(19) United States
(12) Patent Application Publication
(10) Pub. No.: US 2020/0084357 A1
(43) Pub. Date: Mar. 12, 2020

(54) ADAPTIVE SPECTRAL AND HYPERSPECTRAL IMAGING

(71) Applicants: Moshe Salhov, Herzliya (IL); Amir Averbuch, Tel Aviv (IL)

(72) Inventors: Moshe Salhov, Herzliya (IL); Amir Averbuch, Tel Aviv (IL)

(21) Appl. No.: 16/546,896

(22) Filed: Aug. 21, 2019

Related U.S. Application Data
(60) Provisional application No. 62/720,940, filed on Aug. 22, 2018.

(51) Int. Cl. H04N 5/238; H04N 5/235

(52) U.S. Cl. CPC H04N 5/238; H04N 5/2351

(57) ABSTRACT

Camera systems and methods that convert a standard digital camera for use as an adaptive hyperspectral filter (AHSF) camera for adaptive spectral or hyperspectral imaging by adapting a camera output based on camera input conditions. In an embodiment, an AHSF camera is adapted to process spectral or hyperspectral images from a spectral/hyperspectral camera such that the AHSF camera outputs M spectral bands that have the highest energy.

### CROSS REFERENCE TO RELATED APPLICATIONS

This application claims the benefit of priority of U.S. Provisional patent application No. 62/720,940 filed Aug. 22, 2018, which is incorporated herein by reference in its entirety.

### FIELD

Embodiments disclosed herein relate in general to spectral imaging systems and methods.

### BACKGROUND

Spectral imaging (SI) and hyperspectral imaging (HSI) may be performed using various systems (cameras) and methods. In particular snapshot SI and HSI may be performed using known and commercially available cameras. Also known are snapshot SI and HSI using a monochromatic digital camera (i.e. a cameras with a clear (monochromatic) image sensor) that has a minimal hardware addition in the form of a diffuser element. The monochromatic digital camera is adapted to provide a large number of spectral images in a snapshot. The spectral images are reconstructed from a single diffused-dispersed (DD) image, which is a single image obtained at the image sensor through the camera and the diffuser. Some of the reconstruction algorithms may be based on compressed sensing (CS).

In many real life scenarios, a digital camera used for SSI or HSI may suffer from changing lightning and visibility conditions. For example, weather conditions such as fog, snow or rain may cause bad visibility. Furthermore, camera saturation caused by high reflection from snow, fog, rail or other conditions may result in inability of the camera to provide reasonable footage. At night, the problem worsens to the point that a standard (off-the shelf) camera may fail completely (due to saturation and light sensitivity).

There is therefore a need for, and it would be advantageous to have, digital cameras that can provide spectral, hyperspectral or color images that can also overcome adverse bad visibility effects.

### SUMMARY

In various embodiments, there are disclosed camera systems and methods that perform adaptive spectral and hyperspectral imaging. A camera system disclosed herein may convert a standard digital camera for use as an adaptive spectral filter (ASF) camera or an adaptive hyperspectral filter (AHSF) camera.

As used herein, the term “adaptive” refers to a camera that adapts a camera output based on camera input conditions (i.e. based on a camera “input”). As used herein, a spectral (or hyperspectral) filter is a hardware (HW) component or a software (SW) component that performs mathematical operations on a sampled, discrete-time spectral cube to reduce or enhance certain aspects of that cube. The SW filter can run on a processor of the camera or on a separate processor. The AHSF camera is adapted to process hyperspectral images (“input”) from a hyperspectral camera such that the AHSF camera outputs M spectral bands that have the highest energy (“output”). For example, during daytime, when lighting conditions are good, an AHSF camera disclosed herein may output M images from all the visible (VIS)+near infrared (NIR) bands. At nighttime, where lightning conditions are poor, the same AHSF camera may automatically output M images from the NIR band only.

While the description that follows is given in detail for hyperspectral cameras and methods, it is to be understood that it applies equally well to spectral cameras and methods. The differentiation between “spectral” and “hyperspectral” arises from the number of bands a given wavelength range is divided into. While different definitions are given in known art, one generally accepted definition refers to a plurality of up to 10 bands as “spectral” and to bands between 10 and hundreds of bands as “hyperspectral”. This generally accepted definition is by no means limiting.

In one embodiment, the AHSF camera is adapted to process hyperspectral images from a hyperspectral camera and depth indication from a depth estimator per hyperspectral image such that the AHSF camera outputs the M spectral bands that have the largest estimated depth inside the image (in essence, acting as a filter). Thereby, when the image acquisition conditions are such that some of the bands are blocked (for example in fog conditions) the AHSF camera will output the bands that are not blocked (for example the NIR in case of fog).

In exemplary embodiments there are provided camera systems, comprising: a spectral camera; a spectral filter; and a spectral conditioner, wherein the spectral camera is configured to communicate a plurality N of spectral images (im_b_1, . . . , im_b_N) in N spectral bands to the spectral filter and to the spectral conditioner, wherein the spectral conditioner is configured to process the communicated images and to provide at least one control message to the spectral filter, and wherein the spectral filter is configured to translate the at least one control message into a filtering operation performed on the communicated images to generate a set of filtered images that can be combined into at least one output image.

In some embodiments, the spectral filter includes a filter configuration manager operative to translate the at least one control message into a set of coefficients, and a set of NxM multipliers operative to use the set of coefficients to filter the communicated images to generate a set of filtered images (im_o_1, . . . , im_o_M).

In some embodiments, the spectral filter further includes a summing module operative to sum all the multiplied images to generate the at least one output image.

In some embodiments, the spectral conditioner is configured to measure/estimate intensity of light inside at least one light wavelength range and to use the measured/estimated intensity of light as input for the at least one control message.

In some embodiments, the spectral conditioner is configured to measure/estimate saturation of each band of the N spectral bands and to use the measured/estimated saturation as input for the at least one control message.

In some embodiments, spectral images from the spectral camera are processed together with a depth indication per spectral image received from a depth estimator, such that the camera system outputs M spectral bands that have the largest estimated depth inside each spectral image.

In some embodiments, the N spectral bands cover both a visible RGB wavelength range and an infrared (IR) wavelength range and the camera system is adapted to perform as a RGB to IR selector.

In some embodiments, the N spectral bands cover both a visible RGB wavelength range and an IR wavelength range and the camera system is adapted to perform as a fog depth optimizer.

In some embodiments, the N spectral bands cover a visible RGB wavelength range and the camera system is adapted to mitigate saturation.

In some embodiments, the spectral camera is a hyperspectral camera.

In an embodiment, there is provided a method comprising: providing a camera system comprising a spectral camera, a spectral filter and a spectral conditioner; configuring the spectral camera to communicate a plurality N of spectral images (im_b_1, . . . , im_b_N) in N spectral bands to the spectral filter and to the spectral conditioner; configuring the spectral conditioner to process the communicated images and to provide at least one control message to the spectral filter; and configuring the spectral filter to translate the at least one control message into a filtering operation performed on the communicated images to generate a set of filtered images that can be combined into at least one output image.

In a method embodiment, the method further comprises using a filter configuration manager of the spectral filter to translate the at least one control message into a set of coefficients and using a set of MxN multipliers of the spectral filter and the set of coefficients to filter the communicated images to generate a set of filtered images (im_o_1, . . . , im_o_M).

In a method embodiment, the method further comprises using a summing module of the spectral filter to sum all the multiplied images to generate the at least one output image.

### BRIEF DESCRIPTION OF THE DRAWINGS

Aspects, embodiments and features disclosed herein will become apparent from the following detailed description when considered in conjunction with the accompanying drawings, wherein:

FIG. 1A shows an exemplary embodiment of an AHSF camera according to presently disclosed subject matter;

FIG. 1B shows details of an exemplary embodiment of the spectral filter included in the AHSF of FIG. 1A;

FIG. 2 shows in a flow chart an exemplary method of use of an AHSF camera as in FIG. 1A according to presently disclosed subject matter.

### DETAILED DESCRIPTION

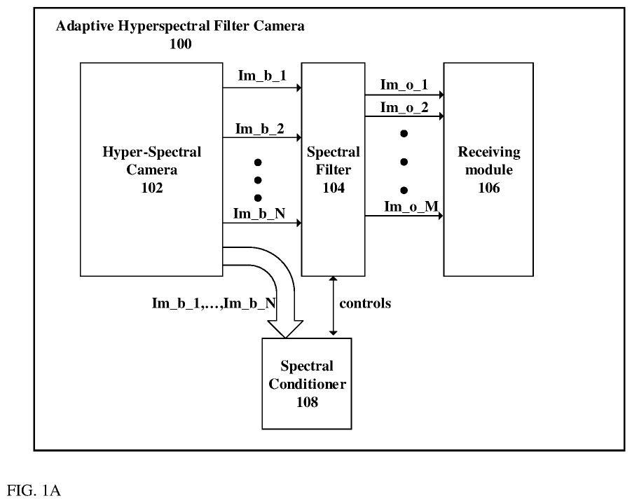

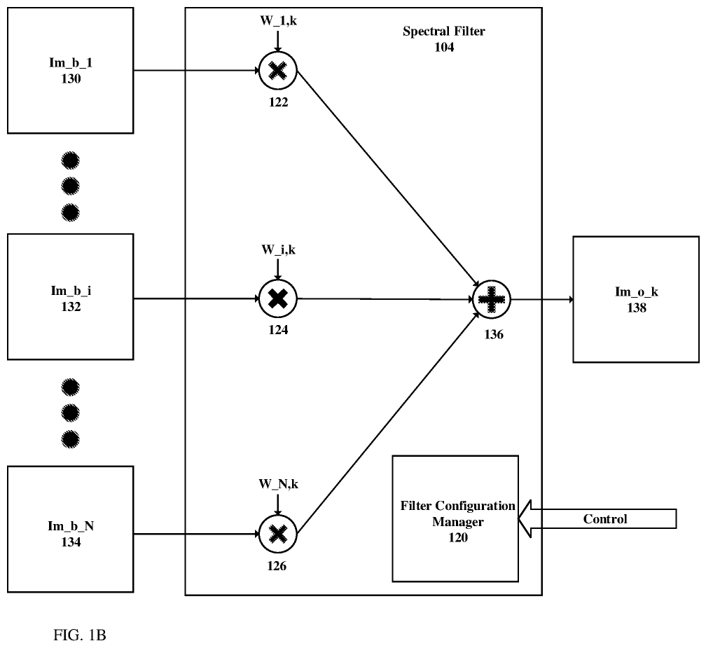

FIG. 1A provides a detailed view of an adaptive spectral/hyperspectral filter camera disclosed herein and numbered 100. AHSF camera 100 includes a spectral or hyperspectral camera 102, a spectral filter module (or simply “spectral filter”) 104, a receiving module 106 (e.g. a screen, a computer vision device or a sensor) and a spectral conditioner 108. Hyperspectral camera 102 is operational (or “configured” or “adapted”) to communicate hyperspectral images (im_b_1, . . . , im_b_M) to spectral filter 104 and to spectral conditioner 108. Spectral conditioner 108 processes the communicated images and provides control messages to spectral filter 104. The processing of the communicated messages may include processing that uses additional information such as time of day, weather conditions, etc. Spectral filter 104 translates the provided control messages into a filtering operation performed on the communicated images, to generate a set of filtered images (im_o_1, . . . , im_o_M). The filtered images are communicated to receiving module 106.

Optionally, the spectral filter and/or the spectral conditioner can be implemented as software modules in a processor that also runs algorithms for image reconstruction for an acquired spectral cube (not shown).

FIG. 1B shows an exemplary embodiment of spectral filter 104. While in the exemplary embodiment the spectral filter is presented as a module that aims to compute only the k^{th} output image, the same module can be used with different coefficients to compute any output image. That is, the filtering operation is described for a single output image but is equally applicable for any other image from the M outputs (with different coefficients). Spectral filter 104 includes a filter configuration manager 120 and a set of multipliers 122, 124 and 126. Spectral filter 104 is adapted to receive a control message that may originate from spectral conditioner 108. The control message is translated by a filter configuration manager 120 into a set of coefficients. The coefficients are loaded into the set of multipliers 122, 124 and 126. Further, spectral filter 104 is adapted to receive a set of images 130, 132 and 134 that are generated by hyperspectral camera 102, and is further adapted to filter images 130, 132 and 134 using the configured coefficients using multipliers 122, 124 and 126. Further still, spectral filter 104 is adapted to sum all the multiplied images using a summing module 136 to generate an output image 138.

The following reconstruction flow describes the processing flow of N spectral or hyperspectral images im_b_1-im_b_N to produce an output image Im_o_k. It is to be understood that where the term “hyperspectral” is used, it may also refer to “spectral”. The spectral cube includes N bands (the “_b” in the image numbering). Each image in the cube im_b_i (1≤i≤N) is multiplied by a filter coefficient W_i,k. Index i relates to the input hyperspectral image and index k relates to the output image i.e., 1≤k≤M where M is the number of output images. To produce M output images, we have N×M coefficients.

### Conditioning Operation Performed by the Spectral Conditioner

Given a spectral cube with N bands generated by a hyperspectral camera of any kind, the cube is communicated to the spectral conditioner and to the spectral filter. The spectral conditioner processes the images (or alternatively is configured to operate according to some predetermined rules) and outputs a control message to the spectral filter. The spectral filter is adapted to receive the control message and to configure the N×M multipliers accordingly (either from its own memory or from the control message). Each image is multiplied by the corresponding coefficient to produce the output images im_o_1, . . . , im_o_M.

### Example of Determining Best M Images

In an example, the best M images in terms of depth may be chosen, using for example combinations from available computer vision algorithms such as depth estimation. A “depth estimator” is broadly defined herein as any device structurally configured for estimating a depth field from imaging data (e.g. a single image of mono-color or RGB, or a sequence of such images). A non-limiting example may be found in David Eigen, Christian Puhrsch and Rob Fergus. “Depth map prediction from a single image using a multi-scale deep network.” Advances in neural information processing systems, 2014. In one embodiment, the AHSF camera is adapted to process hyperspectral images from a hyperspectral camera and depth indication per hyperspectral image received from a depth estimator (not shown), such that the AHSF camera outputs the M spectral bands that have the largest estimated depth inside the image. Many depth estimators known in the art can be used for this purpose. Thereby, when the image acquisition conditions are such that some of the bands are blocked (for example in fog conditions) the AHSF camera will output only the bands that are most informative in terms of depth information (for example the NIR bands in case of fog).

### EXAMPLES

1. RGB to IR selector: in an example, the source hyperspectral camera produces N=130 bands spanning from 400 nm to 1700 nm. (1300 nm/130=10 nm wide). For each produced spectral cube, the spectral conditioner is adapted or configured to measure/estimate the intensity of light in the range 400-720 nm (for example by summing all the relevant bands) and is adapted to measure/estimate the intensity of light in the range 900-1700 nm. The spectral conditioner is further configured to decide in which range the light is more intense based on the estimations, and it is further adapted to produce a control message to the spectral filter. In one embodiment, the control message includes coefficients W_i,K_R, W_i,K_G and W_i,K_B to produce a RGB image and/or coefficients W_i,k to produce a short wave IR (SWIR) image. Thereby, for each produced spectral cube, the most intense band is selected and translated into an image that can be processed by the receiving module.

The data for the IR case (i.e. for a band that is higher than 720 nm) includes M=1: W_j,1=1/80 for any i that corresponds to a band in the range 900 nm-1700 nm. Otherwise w_j,1=0;

2. Fog depth optimizer: in another example, the source hyperspectral camera produces N=130 bands spanning from 400 nm to 1700 nm. (1300 nm/130=10 nm wide). For each produced spectral cube, the spectral conditioner is adapted to measure/estimate the depth of each band in the cube and give it a depth score. This estimation can be done as known in the art. Given the estimated depth, the spectral conditioner is adapted to produce a control message to the spectral filter that includes information (like a specific band index i, or a specific coefficient) on the depth score of each image. The spectral filter is adapted to translate the depth score into a coefficient W_i,k. The filter is further adapted to multiply each image in the cube by the corresponding W_i,k to produce the output image cube.

In yet another example, the output cube includes M=3 output images, where each output image is computed according to the following logic/table: if the depth score of each image in the visible range is sufficiently large (30 m for example) than a RGB image is computed by utilizing coefficients W_i,K_R, W_i,K_G and W_i,K_B that are adapted for RGB image generation. Otherwise, the indexes of the 3 bands with the largest depth score are selected by setting their coefficient W_i,k to 1. All other coefficients are set to 0. Thereby, the receiving module always receives the image set that consists of the largest depth information.

3. Saturation mitigation: in yet another example, the source hyperspectral camera produces a spectral cube with N=33 bands spanning from 400 nm to 730 nm. For each produced spectral cube, the spectral conditioner is adapted to measure/estimate the saturation of each band in the cube. This estimation can be done as known in the art. Given the estimated saturation per image, the spectral conditioner is adapted to produce a message to the spectral filter that includes information (like a specific band index i, or a specific coefficient) on the saturation score of each image. The spectral filter is adapted to translate the saturation score into a coefficient W_i,k. The spectral filter is further adapted to multiply each image in the cube by the corresponding W_i,k to produce the output image cube. In one embodiment, the output cube consists of M=3 output RGB images, where each output image is computed according to the following logic/table: if the saturation score of any band in RGB band related images 1≤i≤33 is sufficiently low (e.g. about zero), then a RGB image is computed by utilizing coefficients W_j,K_R, W_j,K_G and W_j,K_B that are adapted for RGB image generation. Otherwise, the coefficient W_i,k that corresponds to any image with a saturation score larger than 0 is set to 0. Thereby, the receiving module receives an estimated RGB image that ignores any band that is saturated.

While this disclosure describes a limited number of embodiments, it will be appreciated that many variations, modifications and other applications of such embodiments may be made.

All references mentioned in this specification are herein incorporated in their entirety by reference into the specification, to the same extent as if each individual reference was specifically and individually indicated to be incorporated herein by reference. In addition, citation or identification of any reference in this application shall not be construed as an admission that such reference is available as prior art to the present application.

What is claimed is:

1. A camera system, comprising:
a) a spectral camera;
b) a spectral filter; and
c) a spectral conditioner, wherein the spectral camera is configured to communicate a plurality N of spectral images (im_b_1, . . . , im_b_N) in N spectral bands to the spectral filter and to the spectral conditioner, wherein the spectral conditioner is configured to process the communicated images and to provide at least one control message to the spectral filter, and wherein the spectral filter is configured to translate the at least one control message into a filtering operation performed on the communicated images to generate a set of filtered images that can be combined into at least one output image.

2. The camera system of claim 1, wherein the spectral filter includes a filter configuration manager operative to translate the at least one control message into a set of coefficients, and a set of NxM multipliers operative to use the set of coefficients to filter the communicated images to generate a set of filtered images (im_o_1, . . . , im_o_M).

3. The camera system of claim 2, wherein the spectral filter further includes a summing module operative to sum all the multiplied images to generate the at least one output image.

4. The camera system of claim 1, wherein the spectral conditioner is configured to measure/estimate intensity of light inside at least one light wavelength range and to use the measured/estimated intensity of light as input for the at least one control message.

5. The camera system of claim 1, wherein the spectral conditioner is configured to measure/estimate saturation of each band of the N spectral bands and to use the measured/estimated saturation as input for the at least one control message.

6. The camera system of claim 1, wherein spectral images from the spectral camera are processed together with a depth indication per spectral image received from a depth estimator, such that the camera system outputs M spectral bands that have the largest estimated depth inside each spectral image.

7. The camera system of claim 1, wherein the N spectral bands cover both a visible RGB wavelength range and an infrared (IR) wavelength range and wherein the camera system is adapted to perform as a RGB to IR selector.

8. The camera system of claim 4, wherein the N spectral bands cover both a visible RGB wavelength range and an infrared (IR) wavelength range and wherein the camera system is adapted to perform as a fog depth optimizer.

9. The camera system of claim 5, wherein the N spectral bands cover a visible RGB wavelength range and wherein the camera system is adapted to mitigate saturation.

10. The camera system of claim 1, wherein the spectral camera is a hyperspectral camera.

11. A method, comprising:
a) providing a camera system comprising a spectral camera, a spectral filter and a spectral conditioner;
b) configuring the spectral camera to communicate a plurality N of spectral images (im_b_1, . . . , im_b_N) in N spectral bands to the spectral filter and to the spectral conditioner;
c) configuring the spectral conditioner to process the communicated images and to provide at least one control message to the spectral filter; and
d) configuring the spectral filter to translate the at least one control message into a filtering operation performed on the communicated images to generate a set of filtered images that can be combined into at least one output image.

12. The method of claim 11, further comprising:
using a filter configuration manager of the spectral filter to translate the at least one control message into a set of coefficients, and
using a set of M×N multipliers of the spectral filter and the set of coefficients to filter the communicated images to generate a set of filtered images (im_o_1, . . . , im_o_M).

13. The method of claim 12, further comprising:
using a summing module of the spectral filter to sum all the multiplied images to generate the at least one output image.

14. The method of claim 11, wherein the providing a camera system comprising a spectral camera includes providing a camera system that comprises a hyperspectral camera.
